(19) United States
(12) Patent Application Publication
(10) Pub. No.: US 2007/0105788 A1
(43) Pub. Date: May 10, 2007

(54) Azithromycin for treatment of granulomatous rosacea

(76) Inventors: Serena Mraz-Gernhard, Novato, CA (US); Jeffrey Sugarman, Santa Rosa, CA (US)

Correspondence Address: HOWARD EISENBERG, ESQ., 1220 LIMBERLOST LANE, GLADWYNE, PA, 19035, US

(21) Appl. No.: 11/594,451

(22) Filed: Nov. 8, 2006

Related U.S. Application Data
(60) Provisional application No. 60/734,843, filed on Nov. 9, 2005.

(51) Int. Cl. A01N 45/00

(52) U.S. Cl. 514/26

(57) ABSTRACT

Systemic administration of azithromycin for a period of at least two weeks is effective in ameliorating the signs and symptoms of granulomatous rosacea, a variant form of rosacea that often fails to respond favorably to treatment regimens that are effective against forms of rosacea other than granulomatous rosacea.

This Application claims the benefit of pending U.S. Provisional Patent Application Ser. No. 60/734,843, filed on Nov. 9, 2005.

### FIELD OF THE INVENTION

The present invention pertains to the field of pharmacological therapy of disease. In particular, the invention pertains to the field of pharmacological therapy of granulomatous rosacea.

### BACKGROUND OF THE INVENTION

Rosacea, also called acne rosacea, is a chronic dermatitis of the skin of the face. It is characterized by persistent erythema and often by telangiectasia with acute episodes of edema, papules, and pustules. Rosacea is said to affect about 14 million people in the United States and is triggered or exacerbated, in susceptible individuals, by a number of factors including sun exposure, hot environments, alcohol and various other foods, and application to the skin of astringents.

Treatment for rosacea includes the avoidance of triggering or exacerbating triggers and the application of topical and internal medications. Various types of medications are used in the treatment of rosacea, oftentimes in combinations. Acne products, such as benzoyl peroxide, immunosuppressants such as tacrolimus, and retinoids such as isotretinoin have shown efficacy in the treatment of rosacea. A topical antibiotic medication that has been shown to be effective in the therapy of rosacea is metronidazole, i.e. METROGEL® (Galderma Laboratories, Fort Worth, Tex., USA). Systemic antibiotics that are used to treat rosacea include clindamycin, erythromycin, tetracycline, minocycline, doxycycline, clarithromycin, and azithromycin. Azithromycin is administered for treatment of rosacea for a period of about 5 days at a level of 250 mg/day, often with a loading dose of 500 mg on day 1.

Granulomatous rosacea is a variant of rosacea in which discrete papules occur on the medial and lateral facial areas of the face and periorally. Histologically, the papules in granulomatous rosacea, which typically are hard and vary in color from yellowish brown to red, are non-caseating epithelioid cell granulomas. These granulomas are not found in other forms of rosacea. Because of the presence of granulomas, there has been some question as to whether granulomatous rosacea is truly a variant of rosacea or whether it is a separate disease or a variant of another granulomatous disorder of the skin. See, for example, Kaur, et al, “Granulomatous Rosacea: Is it a variant of lupus miliaris disseminatus faciei?”, Indian Journal of Dermatology, Venereology, and Leprology, 69(7): 58-60 (2003).

Granulomatous rosacea has proven to be a difficult disease to treat. Most treatments that are effective for other various subtypes of rosacea are ineffective in the treatment of granulomatous rosacea. A significant need exists for an effective therapy for granulomatous rosacea.

### DESCRIPTION OF THE INVENTION

It has been surprisingly discovered that azithromycin, administered systemically for a period of several weeks or more, is effective in treating the signs and symptoms of granulomatous rosacea.

The invention is a method for treating the signs and symptoms of granulomatous rosacea in an individual suffering from such signs and symptoms by systemically administering azithromycin to the individual at a dosage and for a period of time sufficient to ameliorate the signs and symptoms of granulomatous rosacea in the individual.

The azithromycin used for the method of the invention may be any form of azithromycin. Such forms include non-crystalline and crystalline azithromycin. Crystalline forms of azithromycin include dihydrate and monohydrate forms.

Administration of azithromycin for the treatment of granulomatous rosacea is systemic. Such systemic administration includes both enteral and parenteral routes of administration. Examples of systemic administration suitable for the method of the invention include injection, such as intravenous, intramuscular, and subcutaneous, and oral administration, such as by swallowing tablets or capsules, including immediate release and delayed release tablets and capsules.

The dosage of azithromycin that is used in accordance with the method of the invention is a dose that is effective to ameliorate the signs and symptoms of granulomatous rosacea in a person suffering from this disorder. Typically, a daily dose of 100 to 1000 mg of azithromycin is administered. Preferably, the daily dose is between 150 mg and 750 mg. Most preferred is a daily dose of up to about 500 mg, such as between 175 to 350 mg.

An alternative dosing regimen is an every other day regimen in which a patient receives between 250 mg and 1000 mg on alternate days, preferably between 250 mg and 750 mg on alternate days, and most preferably about 500 mg on an alternating day basis. The every other day dose regimen may be utilized following an initial period of daily dosing of azithromycin, if desired.

Other dosing regimens are also possible under this invention including once weekly dosage in which a total weekly dose is provided that equals the total weekly amounts that would be administered under the above described daily dosing above. For example, a typical weekly dose of azithromycin could be between 700 mg and 7000 mg administered as a single weekly dose. Additional variations in dosing schedule are also possible, for example to provide the same weekly amount of azithromycin by administering 2 or 3 doses per week.

An alternative dosing schedule is as a cycle therapy. Cycle therapy means dosing for a period of time, such as for one week, followed by a rest period (no administration of azithromycin) for a period of time typically the same as that for the dosing period, for example one week. The cycle of dosing and rest is then repeated. Thus, for the week on/week off cycle, the total treatment duration could be as little as 2 cycles or as many as 13 cycles or even more if desired. An alternative preferred treatment cycle is a one-month treatment, with any of the described dosing schedules within each week such as described above, and a one-month rest period.

The duration of therapy with azithromycin to ameliorate the signs and symptoms of granulomatous rosacea will vary according to the severity of the condition in an individual and the individual's response to azithromycin therapy. Preferably, azithromycin is administered for at least two weeks, preferably for four weeks or more, and more preferably for at least two months. Generally therapy should be continued until clinically significant clearance is observed. Treatment with azithromycin in accordance with the invention may last for as long as 6 months or even longer.

Moreover, in the event that an individual's granulomatous rosacea worsens after the initial treatment with azithromycin as described above, additional courses of therapy may be utilized in accordance with the invention to bring the disease back into control.

If desired, the azithromycin may be administered to an individual suffering from signs and symptoms of granulomatous rosacea in combination with other auxiliary medications and therapies. Examples of such auxiliary medications include hormones such as sex hormones like estrogens, retinoids such as isotretinoin, and other topical medications such as azaleic acid (FINACEA®, Intendis, Montville, N.J.), sodium sulfacetamide 10% with sulfur 5% (ROSAC® Cream with Sunscreens, Stiefel Laboratories, Coral Gables, Fla.), and/or metronidazole (METROGEL®, Galderma Laboratories, Fort Worth, Tex.). Topical and or systemic medications known to be effective in the treatment of forms of rosacea other than granulomatous rosacea may be administered in combination with the azithromycin.

The method of the invention is especially well suited for treating cases of granulomatous rosacea that have not responded favorably, or have responded less favorably than is desired, to other therapy. Such unsuccessful therapies include treatments with antibiotics other than azithromycin, including with antifungal medications such as naftifine hydrochloride (NAFTIN®, Merz, Pharmaceuticals, Greensboro, N.C.), and treatment with azithromycin for a time shorter than 2 weeks.

The method of the invention is further illustrated in the following non-limiting examples.

### EXAMPLE 1

A 34 year old Hispanic female patient presented with severe inflammatory diffuse facial granulomatous rosacea. The condition had been present for 6 years. Prior treatment with the antibiotic doxycycline had produced no improvement.

She was started on oral azithromycin 500 mg daily dose together with an estrogenic hormone, norgestimate/ethinyl estradiol (ORTHO TRI-CYCLEN®, Ortho-McNeil Pharmaceutical, Raritan, N.J.). The patient was greatly improved with only minimal residual facial erythema and no residual inflammatory lesions on representation 9 weeks after initiation of azithromycin therapy. At that time, the dose of azithromycin was reduced to 500 mg every other day and topical azaleic acid was applied daily. The patient remained clear on a follow-up examination two months later. Treatment was continued with a follow-up examination expected in another 6 to 8 weeks.

### EXAMPLE 2

A 70 year old Caucasian male patient presented with complaints of a “facial rash”. On physical exam the patient had malar erythema with large papules on the nose, cheeks, forehead, and on the trunk. Blepharitis was also reported. He was started on oral cephalexin. One month later, the patient returned with worsening pustules and tender nodules worse on both sides of the face. A biopsy was obtained from the right jaw and the pathology revealed “suppurative and granulomatous folliculitis”. Treatment with dicloxicillin was initiated. Six weeks later, the patient was seen in follow-up with persistent severe to worsening involvement and naftifine cream was added.

The patient saw a different dermatologist the next day who diagnosed the problem as granulomatous rosacea. Oral azithromycin at a dosage of 500 mg daily was started, together with daily topical application of a sodium sulfacetamide 10% with sulfur 5% cream and a metronidazole cream. The patient was again evaluated six weeks after initiation of the azithromycin therapy and had, at that time, minimally perceptible residual erythema and papulation. The treatment was continued except that azithromycin was decreased to 500 mg every other day. The patient was again evaluated two months later and had no evidence of residual rosacea. The azithromycin was discontinued.

### EXAMPLE 3

A 59 year old woman presented with a facial rash. Examination revealed erythematous patches and some pustules and papules involving her forehead, hairline, infraorbital area, and nose. A clinical diagnosis of granulomatous rosacea was made.

Treatment was initiated with a variety of topical medications, including metronidazole gel, Elidel® (pimecrolimus, Novartis Pharmaceuticals Corp., New York, N.Y.), 2.4% hydrocortisone, and desonide cream. These topical treatments took place over the course of several months and were ineffectual. Oral tetracycline 500 mg twice daily was then tried, but the patient's condition was not responsive to this therapy.

Following these unsuccessful therapies, the patient was biopsied and the biopsy confirmed the diagnosis of granulomatous rosacea. The next therapy tried was oral doxycycline 100 mg twice daily. This therapy was also unsuccessful. Klaron® Lotion (10% sodium sulfacetamide, Dermik Laboratories, Berwyn, Pa.) also failed to ameliorate the patient's condition. The patient was then started on Accutane® (Hoffman-LaRoche Inc., Nutley, N.J.) at an initial dosage of 20 mg per day, which was subsequently raised to 40 mg per day and then to 60 mg per day. Even at the higher dosages of Accutane®, the patient's condition did not improve.

Treatment was subsequently initiated with azithromycin as the sole therapy, administered orally at a dosage of 250 mg daily for three weeks. The patient's condition underwent a remarkable improvement as her face cleared and she has not had a recurrence of her granulomatous rosacea following cessation of azithromycin therapy.

Further modifications, uses, and applications of the invention described herein will be apparent to those skilled in the art. It is intended that such modifications be encompassed in the following claims.

1. A method for ameliorating the signs and symptoms of granulomatous rosacea comprising systemically administering to an individual suffering from granulomatous rosacea azithromycin at a dosage and for a period of time effective to ameliorate the signs and symptoms of granulomatous rosacea in the individual.

2. The method of claim 1 wherein the azithromycin is administered daily for a period of at least two weeks.

3. The method of claim 1 wherein the azithromycin is administered daily or every other day for a period of at least two weeks.

4. The method of claim 1 wherein the dosage of azithromycin is between 100 and 1000 mg per day.

5. The method of claim 1 wherein the azithromycin is administered orally.

6. The method of claim 1 wherein the azithromycin is administered in combination with the administration of one or more topical medications that are known to be effective in treating a form of rosacea other than granulomatous rosacea.

7. The method of claim 6 wherein the topical medication is selected from the group consisting of hormones, retinoids, azaleic acid, sodium sulfacetamide 10% with sulfur 5%, and metronidazole.

8. The method of claim 1 wherein the azithromycin is administered as the sole therapy in the treatment of the granulomatous rosacea.

9. The method of claim 1 wherein the treatment with azithromycin is initiated following unsuccessful treatment of granulomatous rosacea by administering one or more medications other than azithromycin.
